(19) United States
(12) Patent Application Publication
(10) Pub. No.: US 2008/0309456 A1
(43) Pub. Date: Dec. 18, 2008

(54) Kiosk device

(75) Inventor: Pei-Chuan Liu, Taipei (TW)

Correspondence Address: Troxell Law Office Pllc, Suite 1404, 5205 Leesburg Pike, Falls Church, VA, 22041, US

(73) Assignee: Dali Design Inc.

(21) Appl. No.: 12/010,403

(22) Filed: Jan. 24, 2008

(30) Foreign Application Priority Data
Feb. 26, 2007 (TW) 096203282

(51) Int. Cl. G05B 19/00

(52) U.S. Cl. 340/5.8

(57) ABSTRACT

An kiosk device, which includes a receiver, a memory unit, a central processor, a decoder and a player, wherein the receiver receives signals transmitted from GPS (Global Positioning System) transmitters, or RFID (wireless radio frequency identification) transmitters which activate the central processor that controls the decoder to decode digital data stored in the memory unit and produce information guide data that can be automatically played back by the player. Accordingly, the present invention provides considerable ease of operation and convenience.

### BACKGROUND OF THE INVENTION

(a) Field of the Invention

The present invention relates to a device able to provide information guide and description of scenic spots or products, and more particularly provides an kiosk device which uses global positioning system (GPS) technology or wireless radio frequency technology to automatically activate information guide description and play back of related digital data, and which is able to reduce or eliminate the need for user operation.

(b) Description of the Prior Art

In recent years, an ever increasing number of people are participating in activities such as travel, shopping, visiting exhibitions, and the like; and generally only data in written form is available to introduce scenic spots or products to visitors or are introduced by a tour guide. However, it is not possible to describe the scenic spots or products to everyone or provide visitors with further understanding of the scenic spots or products. Hence, some manufacturers have developed interactive kiosk devices, which provide visitors with immediate access and viewing of related information guide data on scenic spots or products they were to pass through. However, because the operating procedure for such kiosk devices is somewhat tedious, thus, younger or older users can find them difficult to use.

In addition, currently, application of wireless radio frequency identification technology can be seen in interactive information guide systems and methods, as depicted in FIG. 1, which depicts a schematic view of a RFID (wireless radio frequency identification) information guide system and method thereof, wherein RFID technology is used in an interactive information guide system 10 for an exhibition site. The system comprises an electronic product 101 comprising a wireless radio frequency identification sensor chip 1011 and a wireless communication module 1012, wherein the wireless radio frequency identification sensor chip 1011 includes an antenna, and the electronic product 101 is provided with a label identification code (Tag ID); a wireless LAN (local area network) device 102 comprising an antenna; a RFID recorder device 103, which is used to read access the Tag ID of each of the electronic products 101, and the RFID recorder device 103 comprises a RFID read access unit and an antenna; and a host machine 104 comprising a central processing unit 1041; a data bank 1042, which is used to store a plurality of digital data; a series transmission port 1043, which is connected to the RFID recorder device 103; and a network card 1044, which is connected to the wireless LAN device 102. Accordingly, after a user carries the electronic product 101 into an exhibition site, then the Tag ID of the electronic product 101 sends out a request information guide signal, which is received by the RFID recorder device 103, whereupon the series transmission port 1043 transmits the signal to the host machine 104, thereby enabling the host machine 104 to locate the required digital data in the data bank 1042. The signal is then transmitted to the electronic product 101 through the wireless LAN device 102 by wireless communication protocol means, and the exhibition site information guide signal is displayed on a screen of the electronic product 101. When using such RFID technology in an interactive information guide system and method, the electronic product actively emits a request for an information guide signal to enable the system to actively provide the required digital data, thus reducing tedious operation steps by the user. However, because current wireless radio frequency technology is limited by distance, and is easily subject to interference from obstructions, thus, the range of use is subject to definite limitations; moreover, the system incurs substantially greater costs in setting up, which considerably reduces practicability of the system.

### SUMMARY OF THE INVENTION

In light of the shortcomings of the aforementioned prior art structure, the inventor of the present invention, having accumulated years of experience in related arts, has meticulously carried out extensive study and exploration to ultimately design a new improved kiosk device.

A primary objective of the present invention is to provide a kiosk device which is simple and convenient to operate, and which greatly extends the range of use thereof.

In order to achieve the aforementioned objectives, the kiosk device of the present invention comprises a receiver, a memory unit, a central processor, a decoder and a player. A plurality of information guide digital data is stored within the memory unit, and further includes Tag IDs corresponding to the plurality of digital data. The receiver is used to receive a signal transmitted from transmitters, including GPS (Global Positioning System) transmitters, or RFID (wireless radio frequency identification) transmitters or Zigbee (short distance, low speed wireless technology) transmitters, whereupon the central processor is activated to implement comparative identification of the signal and to locate the digital data Tag ID in the memory unit corresponding to the signal, after which the digital data is input into the decoder to undergo decoding to form information guide data able to be played back, at which time the built-in player automatically plays back the information guide data. When the kiosk device is moved by the user, thereby changing coordinates, then digital data of the corresponding Tag ID also changes, thus enabling continuous updating of information guide data being played. Accordingly, tedious operation is eliminated, and provides considerable ease of use and convenience. Because technology of the GPS enables distinguishing coordinate data of global geographical locations, thus, different coordinate data can be provided corresponding to each location, which can be used to serve as Tag IDs, and which also avoid data overlapping problems from occurring, thus facilitating use at each scenic spot on the globe. When the kiosk device is being used within a relatively small spatial range, for example: a market or exhibition, then a wireless radio frequency transmitter can be installed to each product or booth, and the plurality of digital data corresponding to the products or booths stored in the memory unit. Accordingly, when the kiosk device is close to a product or booth, then related information guide data can be similarly automatically played back, thereby achieving the objectives of ease of operation, convenience, and expansion of the range of use.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view depicting a wireless radio frequency identification interactive information guide system and method of the prior art.

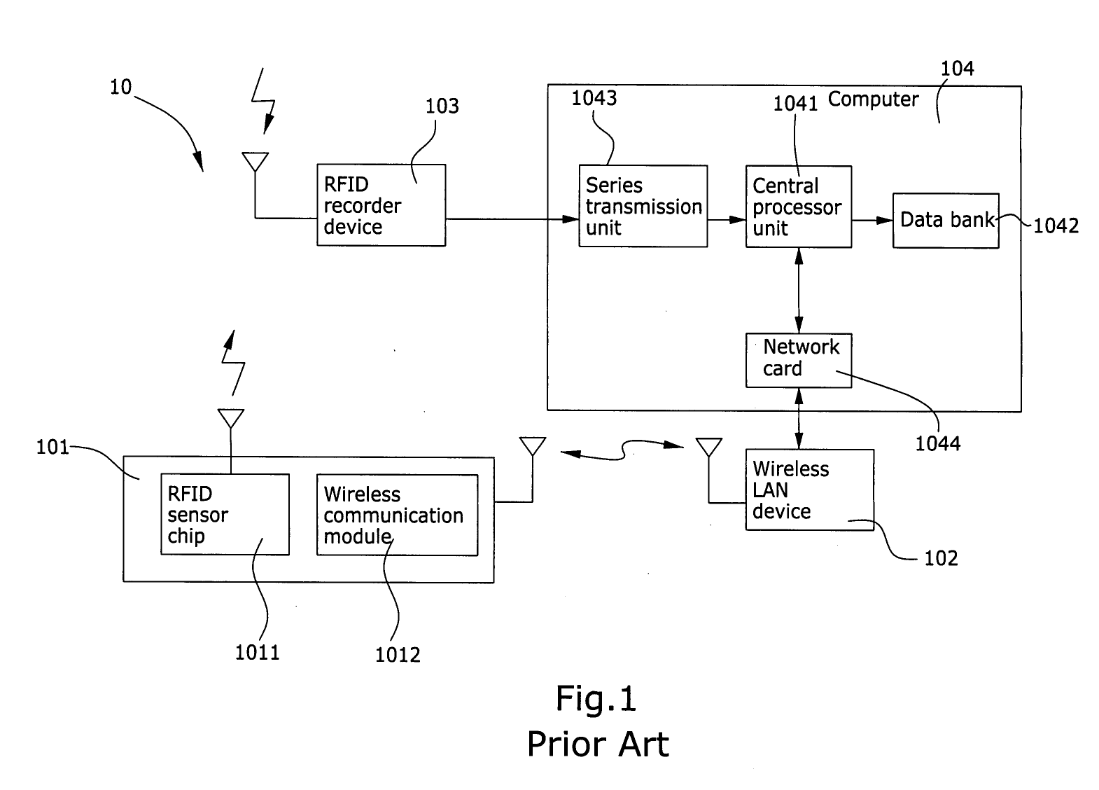

FIG. 2 shows a schematic view depicting a preferred embodiment of the present invention in use.

FIG. 3 shows a hardware block diagram of the preferred embodiment according to the present invention.

FIG. 4 shows a structural schematic view of the preferred embodiment according to the present invention.

FIG. 5 shows a schematic view depicting another preferred embodiment of the present invention in use.

FIG. 6 shows a hardware block diagram of another preferred embodiment according to the present invention.

FIG. 7 shows a structural schematic view of yet another preferred embodiment according to the present invention.

FIG. 8 shows a structural schematic view of yet another preferred embodiment according to the present invention.

### DETAILED DESCRIPTION OF THE PREFERRED EMBODIMENTS

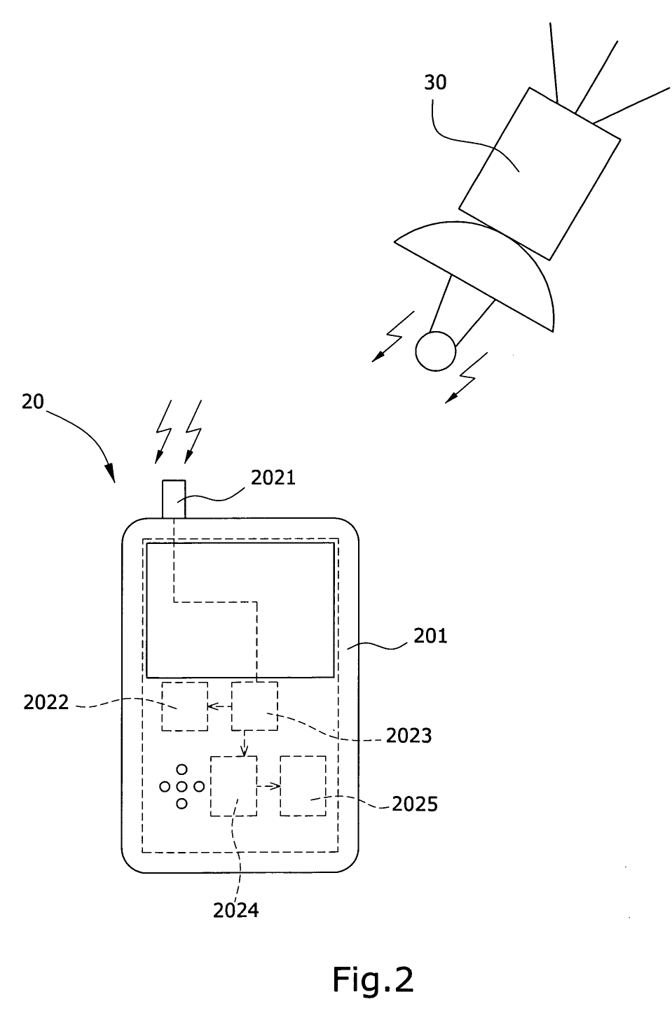

Referring to FIG. 2, which shows a schematic view depicting a preferred embodiment of the present invention in use, wherein a kiosk device 20 has a plurality of information guide digital data stored therein, and further includes Tag IDs corresponding to the plurality of digital data. A receiver 2021 located on a casing 201 is used to receive signals from a GPS (Global Positioning System) 30, and different scenic spots or products can be preset with coordinate data to serve as Tag IDs corresponding to the digital data. Because technology of the GPS 30 enables distinguishing coordinate data of global geographical locations, thus, different coordinate data can be provided corresponding to each location, which can be used to serve as Tag IDs, and which also avoid data overlapping problems from occurring, thus facilitating use at each scenic spot on the globe. Hence, a user is able to carry the kiosk device 20 and move around, and, after the receiver 2021 receives a signal from the GPS 30, a central processor 2023 is activated to implement comparative identification of the signal, and the digital data Tag ID corresponding to the signal is located in a memory unit 2022, after which the digital data is input into a decoder 2024 to undergo decoding, thereby forming information guide data able to be played back, which is automatically played back by a player 2025. When the kiosk device 20 is moved by the user, thereby changing coordinates, then digital data of the corresponding Tag ID also changes, thus enabling continuous updating of information guide data being played. Accordingly, tedious operation is eliminated, and provides considerable ease of use and convenience, as well as expanding the range of use thereof to every corner of the world.

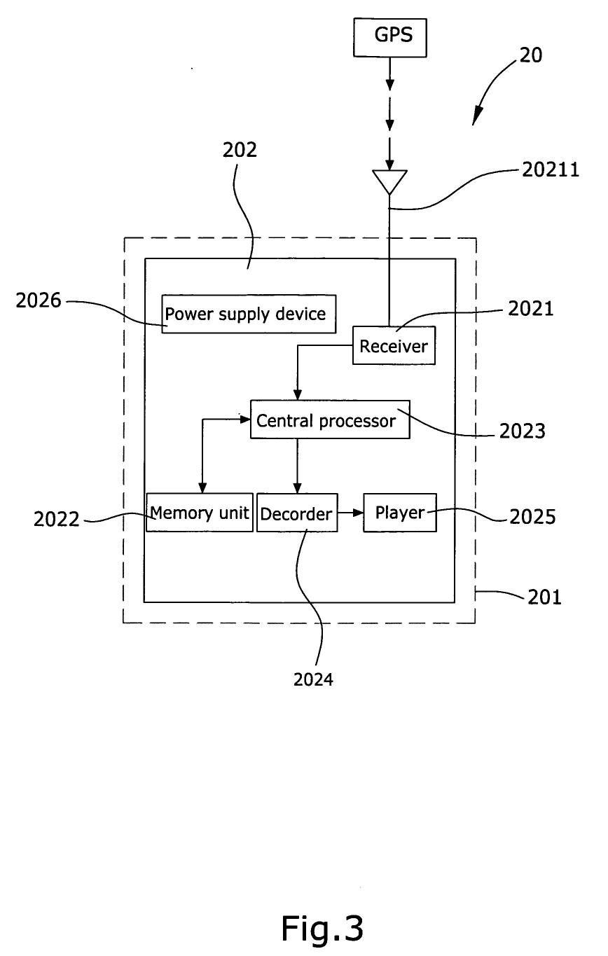

Referring to FIG. 3, which shows a hardware block diagram of the preferred embodiment according to the present invention, wherein the kiosk device 20 comprises a circuit board 202 assembled interior of the casing 201, and the receiver 2021 is assembled to an upper portion of the casing 201. An antenna 20211 of the receiver 2021 can be a concealed type or an exposed type, and is able to actively receive signals from the aforementioned GPS 30. The memory unit 2022 is assembled to the circuit board 202, and the memory unit 2022 stores a plurality of encoded information guide digital data, moreover, the plurality of digital data is respectively provided with a Tag ID. The central processor 2023 is assembled to the circuit board 202, and the central processor 2023 enables comparative identification of signals received by the receiver 2021, and also enables locating the Tag IDs in the memory unit 2022 corresponding to the signals. The central processor 2023 is electrically connected to the receiver 2021, the memory unit 2022, the decoder 2024 and the player 2025.

The decoder 2024 is assembled to the circuit board 202, and after comparative identification of the Tag ID by the central processor 2023, the corresponding digital data in the memory unit 2022 is output into the decoder 2024 to undergo decoding. The player 2025 is assembled within the casing 201, and after the decoder 2024 has decoded the digital data, then the player 2025 automatically plays back the digital data. A power supply device 2026 is assembled to the casing 201 and is used to supply electric power required by the receiver 2021, the central processor 2023, the decoder 2024 and the player 2025. The power supply device 2026 can be a general battery, a rechargeable battery or even a solar energy charging device.

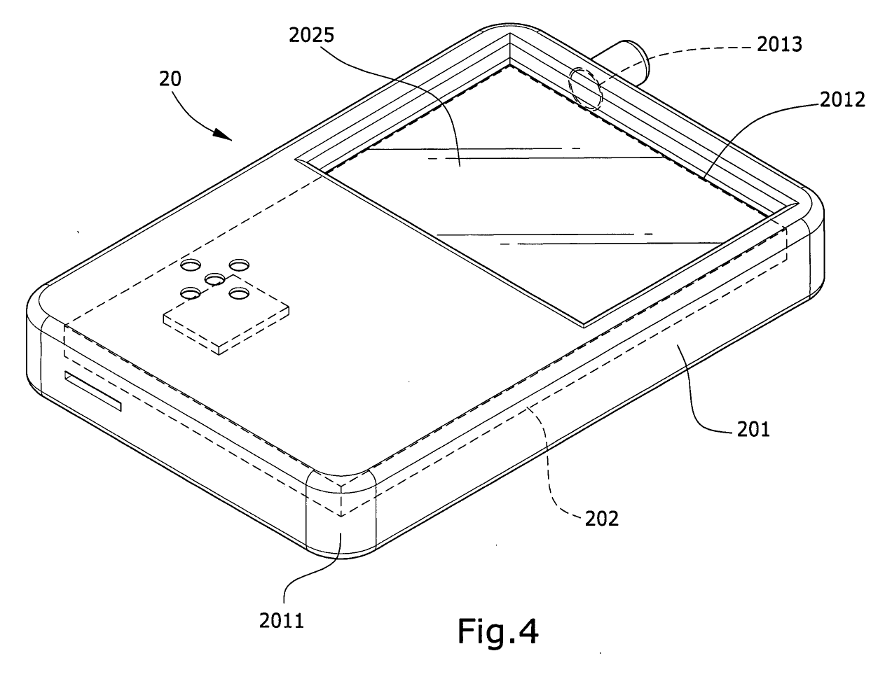

Referring to FIG. 4, which shows a structural schematic view of the preferred embodiment according to the present invention, wherein a space 2011 is formed inside the casing 201 of the kiosk device 20, and the space 2011 is used to dispose the circuit board 202 therein. Moreover, a through hole 2012 is formed in a front surface of the casing 201, thereby enabling the player 2025 to be disposed therein. When assembling, the circuit board 202 is assembled within the space 2011 of the casing 201, thereby providing the effectiveness of protecting the circuit board 2011, and because the antenna 20211 of the circuit board 202 can be a concealed type or an exposed type, thus, an antenna aperture 2013 must be formed in the casing 201. Moreover, the player 2025 is assembled within the through hole 2012 of the front surface of the casing 201. Accordingly, the power source need only be switched on when use of the kiosk device 20 is required.

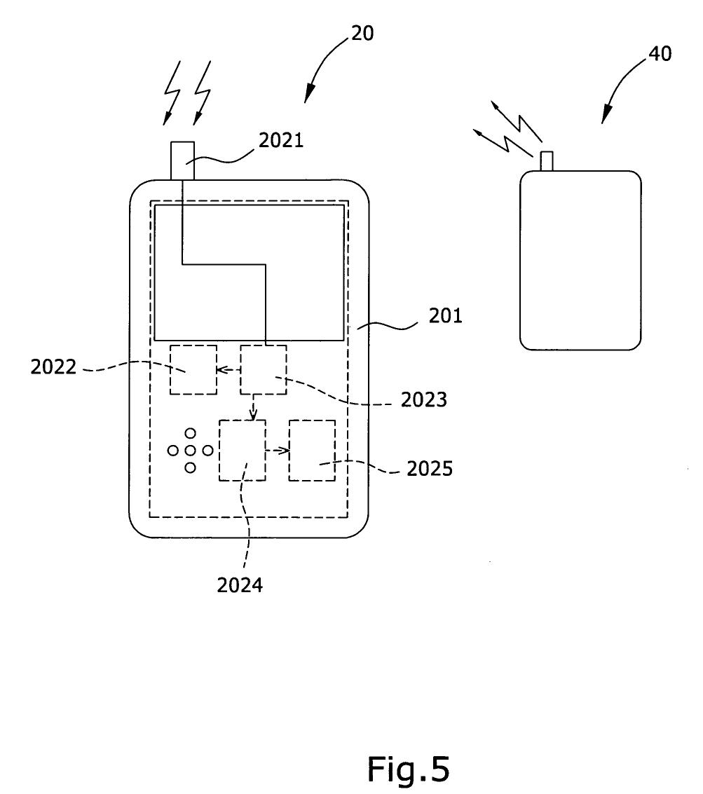

Referring to FIG. 5, which shows a schematic view depicting another preferred embodiment of the present invention in use, wherein, when the kiosk device 20 is being used within a relatively small spatial range, for example: a market or exhibition, then a wireless radio frequency transmitter 40 can be installed to each product or booth, and the plurality of digital data corresponding to the products or booths stored in the memory unit 2022. Accordingly, when the kiosk device 20 is close to a product or booth, the receiver 2021 positioned on the casing 201 receives and identifies the signal transmitted by the wireless radio frequency transmitter 40 using wireless radio frequency identification technology, whereupon the central processor 2023 is activated to implement comparative identification of the signal, and after locating the digital data Tag ID corresponding to the signal, then the digital data is input into the decoder 2024 to implement decoding thereof and form information guide data able to be played back, whereupon the information guide data is automatically played back by the player 2025. When the user moves to the next product or booth carrying the kiosk device 20 along with him, then digital data of the corresponding Tag ID also changes, thereby enabling continuous updating of information guide data being played. Accordingly, tedious operation is eliminated, and provides considerable ease of use and convenience.

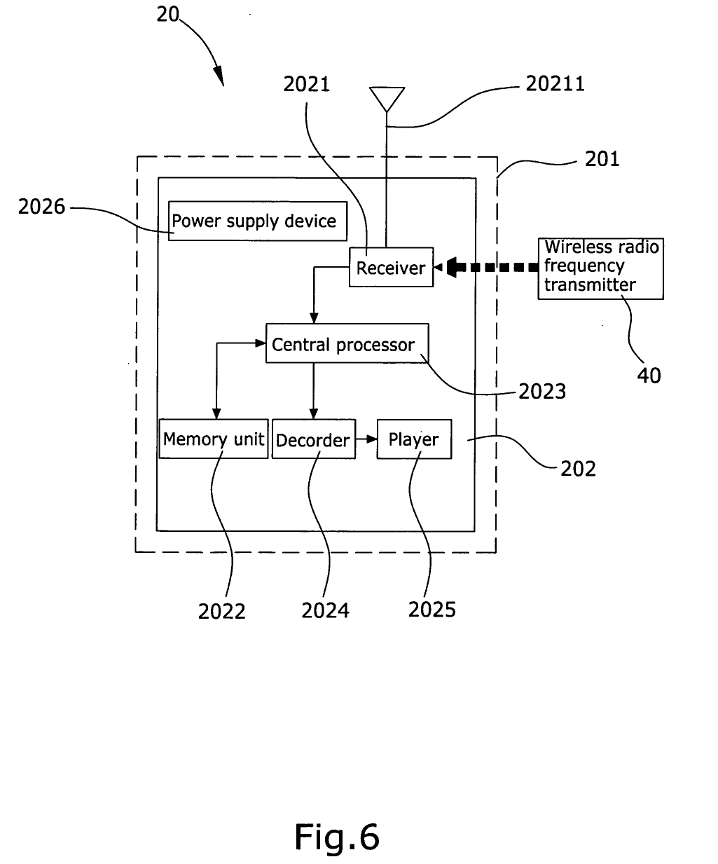

Referring to FIG. 6, which shows a hardware block diagram of another preferred embodiment according to the present invention, wherein the circuit board 202 of the kiosk device 20 is assembled within the casing 201 thereof, and the receiver 2021 is configured to an upper portion of the circuit board 202. Moreover, the antenna 20211 of the receiver 2021 can be a concealed type or an exposed type, and is able to automatically receive signals transmitted by the wireless radio frequency transmitter 40. The memory unit 2022 is assembled to the circuit board 202, and the memory unit 2022 stores a plurality of encoded information guide digital data; the plurality of digital data being respectively provided with a Tag ID. The central processor 2023 is assembled to the circuit board 202; and the central processor 2023 enables comparative identification of signals received by the receiver 2021, and locates the corresponding Tag IDs stored in the memory unit 2022. The central processor 2023 is electrically connected to the receiver 2021, the memory unit 2022, the decoder 2024 and the player 2025. The decoder 2024 is assembled to the circuit board 202, and after comparative identification of the Tag ID by the central processor 2023, then the corresponding digital data stored in the memory unit 2022 is output to the decoder 2024 to undergo decoding. The player 2025 is assembled to the casing 201, and the decoded digital from the decoder 2024 is automatically played back by the player 2025. The power supply device 2026 is assembled to the casing 201 and is used to supply electric power required by the receiver 2021, the central processor 2023, the decoder 2024 and the player 2025. The power supply device 2026 can be a general battery, a rechargeable battery or even a solar energy charging device. Furthermore, a plurality of the wireless radio frequency transmitters 40 are respectfully installed to products or booths, and are used to emit wireless radio frequency signals.

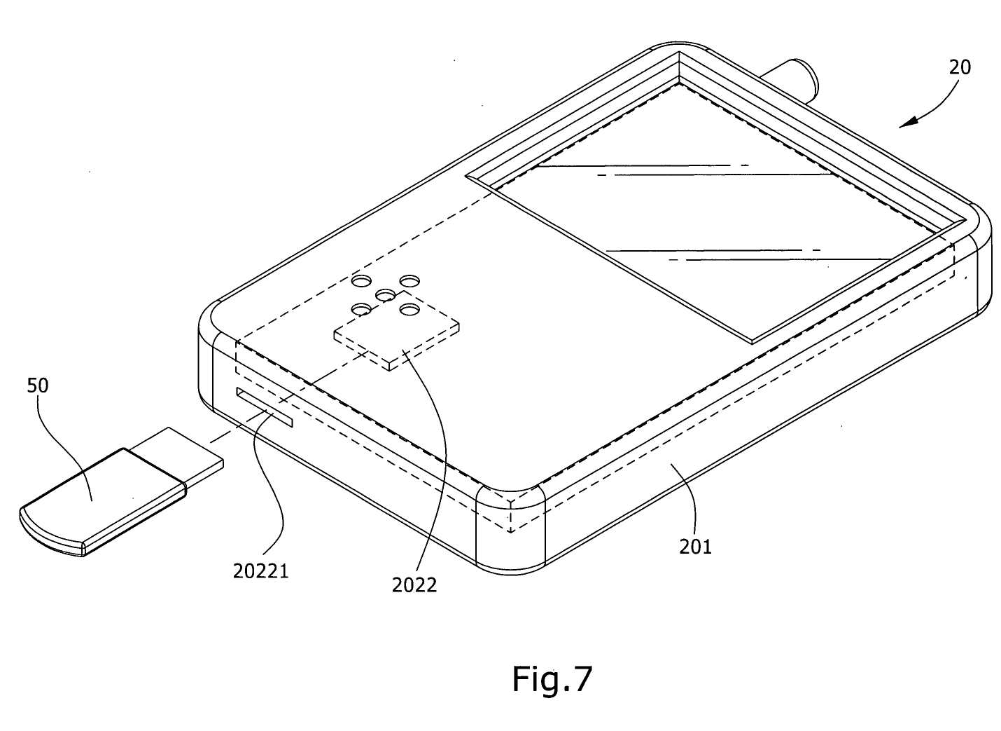

Referring to FIG. 7, which shows a structural schematic view of yet another preferred embodiment according to the present invention, wherein, in order to further increase expandability of the kiosk device 20, apart from the built-in memory unit 2022, the memory unit 2022 can also be electrically connected to a connector port 20221, which is formed in the casing 201, thereby facilitating electrical connection of a portable storage device 50 thereto, and enabling read access to a plurality of digital data stored in the portable storage device 50, thus promptly expanding digital data capacity of the memory unit 2022, and enabling quick replacement of the different storage devices 50 as and when necessary.

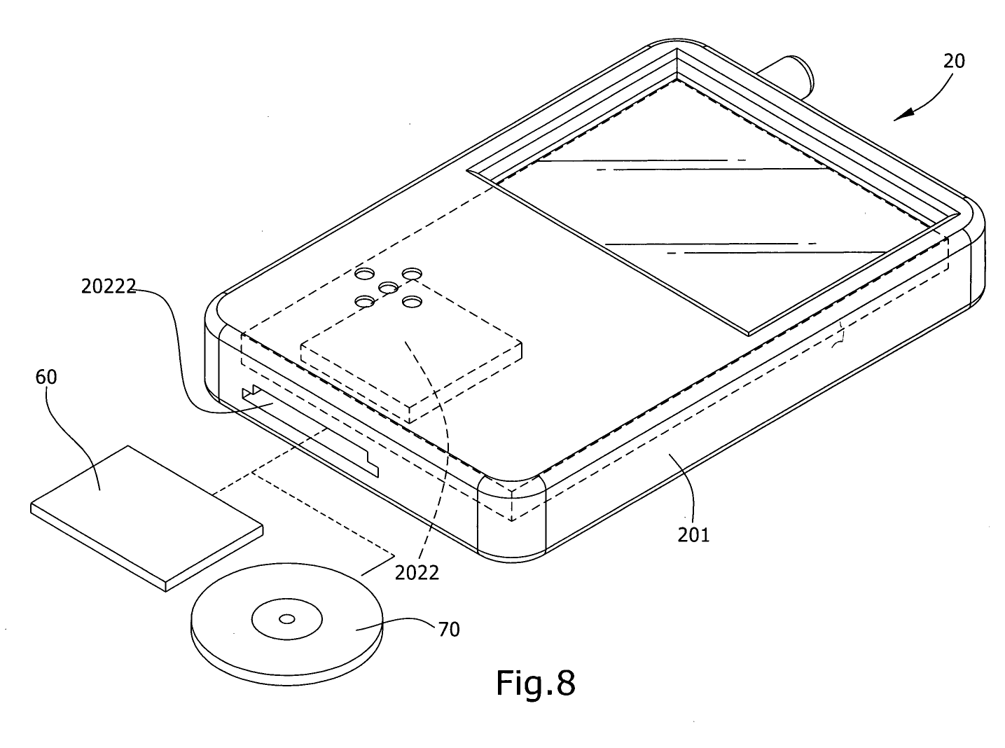

Referring to FIG. 8, which shows a structural schematic view of yet another preferred embodiment according to the present invention, wherein the memory unit 2022 of the kiosk device 20 can also be electrically connected to a read access device 20222, which is formed in the aforementioned casing 201. Moreover, the read access device 20222 can be a card reader or a CD-ROM (Compact Disc Read-Only Memory) drive, which can be used to read access a plurality of digital data stored on a memory card 60 or a CD-ROM 70, thereby similarly increasing expandability, and enabling quick replacement of the corresponding memory card 60 or CD-ROM 70 as and when necessary.

According to the embodiments of the present invention as described above, information guide data of a scenic spot or product can be automatically played back, thereby enabling the user to quickly obtain summarized information guide data on the scenic spot or product, and thus assuredly achieving the objectives of providing a kiosk device which is simple and convenient to operate, and which greatly extends the range of use thereof.

In conclusion, the effectiveness of the kiosk device of the present invention to provide industrial practicability, originality and advancement clearly comply with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A kiosk device, wherein a circuit board assembled within a casing is enabled to receive an outside signal and play back information guide data, the circuit board comprises:
a receiver enabled to actively receive signals;
a memory unit, a plurality of encoded information guide digital data is stored within the memory unit, and the plurality of digital data is respectively provided with a label identification code (Tag ID);
a central processor which implements comparative identification of the signal received by the receiver and locates the corresponding Tag ID in the memory unit, and the central processor is electrically connected to the receiver, the memory unit, a decoder and a player;
the decoder, after undergoing comparative identification of the Tag ID by the central processor, the corresponding digital data in the memory unit is output to the decoder for decoding;
the player, the player is assembled to the casing, and, after passing through the decoder, the decoded digital data is automatically played back by the player;
a power supply device used to supply electric power required by the receiver, the central processor, the decoder and the player.

2. The kiosk device according to claim 1, wherein the receiver receives signals from a GPS (Global Positioning System).

3. The kiosk device according to claim 1, wherein the receiver receives signals transmitted by a wireless radio frequency transmitter.

4. The kiosk device according to claim 1, wherein the receiver can receive signals transmitted by a Zigbee transmitter.

5. The kiosk device according to claim 1, wherein the memory unit is electrically connected to a connector port; the connector port is formed in the casing, thereby facilitating electrical connection of a portable storage device thereto, and enabling read access to a plurality of digital data stored in the portable storage device.

6. The kiosk device according to claim 1, wherein the memory unit is electrically connected to a read access device; the read access device is formed in the casing.

7. The kiosk device according to claim 6, wherein the read access device is a card reader, thereby enabling read access to a plurality of digital data stored on a memory card.

8. The kiosk device according to claim 6, wherein the read access device is a CD-ROM (Compact Disc Read-Only Memory) drive, thereby enabling read access to a plurality of digital data stored on a CD-ROM.

9. The kiosk device according to claim 1, wherein the power supply device is a general battery.

10. The kiosk device according to claim 1, wherein the power supply device is a rechargeable battery.

11. The kiosk device according to claim 1, wherein the power supply device is a solar energy charging device.
